(19) United States
(12) Patent Application Publication
(10) Pub. No.: US 2017/0343075 A1
(43) Pub. Date: Nov. 30, 2017

(54) PENDULUM-TYPE DAMPING DEVICE

(71) Applicant: VALEO EMBRAYAGES, Amiens (FR)

(72) Inventors: Giovanni GRIECO, Colombes (FR); Roel VERHOOG, Gournay Sur Aronde (FR)

(73) Assignee: VALEO EMBRAYAGES, Amiens (FR)

(21) Appl. No.: 15/602,931

(22) Filed: May 23, 2017

(30) Foreign Application Priority Data
May 24, 2016 (FR) 16 54627

(51) Int. Cl. F16F 15/14; F16F 15/12

(52) U.S. Cl. CPC F16F 15/1414; F16F 15/1201; F16F 2238/022; F16F 2236/08

(57) ABSTRACT

A vehicle transmission system component including a first subassembly having an input and an output, between which a torque can be transmitted. A second subassembly forms a pendulum-type damping device, and disposed outside the path of the torque transmitted by the first subassembly. The first and the second subassemblies are connected to one another by at least one connecting element capable of being elastically deformed circumferentially.

The present invention relates to a pendulum-type damping device, especially for a motor vehicle transmission system.

In such an application, the pendulum-type damping device may be integrated with a torsion damping system of a clutch capable of selectively coupling the combustion engine to the gearbox, in order to filter the vibrations due to rotational irregularities of the engine. One example of such a torsion damping system is a damping double flywheel.

Alternatively, in such an application, the pendulum-type damping device may be integrated in a friction disk of the clutch or in a hydrodynamic torque converter or in a flywheel integral with the crankshaft or in a dry or wet double clutch.

Such a pendulum-type damping device traditionally employs a support and one or more pendulum-type members capable of moving relative to this support, wherein the displacement of each pendulum-type member relative to the support is guided by one or more rolling means.

When torques of elevated value, also referred to as “overtorques” hereinafter, propagate in the transmission system in which the pendulum-type damping device is installed, large forces may be applied on the support of the device, which is rigidly connected to an element of this transmission system. The support or any intermediate piece permitting this rigid connection between the support and the transmission system element may then be weakened or even broken. Such overtorques are produced in particular when the pendulum-type damping device is integrated in a friction disk of the clutch, since the pendulum-type damping device may then be subjected directly to the torque coming from the gearbox shaft, i.e. to the torque of the vehicle wheels.

In order to protect the pendulum-type damping device from such elevated torque values, it is known, for example from Application WO 2013/034125, to install a pendulum-type damping device on a shaft and to interpose, between this shaft and the support of the pendulum-type damping device, a washer that functions as a torque limiter. A torque limiter is expensive and cumbersome, with a poorly precise starting torque.

Application DE 10 2013 202 686 discloses tabs connecting a pressure plate and a support for a pendulum-type damping device. These tabs are flat and non-waved, such that they are not elastically deformable, speaking circumferentially.

The object of the invention is to protect the pendulum-type damping device from overtorques, especially by ensuring that shear forces, regardless of their nature, cannot damage the pendulum-type damping device.

The invention achieves this, according to one of its aspects, by means of a vehicle transmission system component comprising:
a first subassembly having an input and an output, between which a torque can be transmitted, and
a second subassembly forming a pendulum-type damping device, and disposed outside the path of the torque transmitted by the first subassembly,
   wherein the first and the second subassemblies are connected to one another by at least one connecting means capable of being elastically deformed circumferentially.

The connection assured between the first subassembly disposed in the torque path and the pendulum-type damping device thus makes it possible to absorb, at least partly or even completely, the overtorques by virtue of the elastic deformation that this connection permits. In contrast to the case of a torque limiter, the connecting means permanently connects, with non-zero stiffness, the first and the second subassembly, including when overtorques are produced.

The connecting means is also able to ensure centering of the pendulum-type damping device on the first subassembly.

Within the meaning of the present Application:
“axially” means “parallel to the axis of rotation of the support of the pendulum-type damping device”,
“radially” means “along an axis in a plane orthogonal to the axis of rotation of the support of the pendulum-type damping device and intersecting that axis of rotation of the support”,
“angularly” or “circumferentially” means “around the axis of rotation of the support of the pendulum-type damping device”,
“orthoradially” means “perpendicular to a radial direction”,
“integral with” means “rigidly coupled with”,
the rest position of the pendulum-type damping device is that in which its pendulum-type members are held centrifugally without being subjected to torsional oscillations due to rotational irregularities of the combustion engine.

The connecting means may also be elastically deformable axially. Stated otherwise, in this case the connection between the first sub-component disposed in the torque path and the pendulum-type damping device permits elastic deformation not only in the circumferential sense but also in the axial sense. Such a connection then also makes it possible to compensate for axial pumping or flexions taking place around an axis perpendicular to the axis of rotation of the support and propagating in the transmission system.

The connecting means may comprise at least one waved part. This waved part may have, along a circumferential trajectory, a succession of zones axially offset in pairs.

The second subassembly forming the pendulum-type damping device may be disposed radially exterior to the first subassembly. The radially external surface of the first subassembly may define a succession of radial teeth, and the radially internal surface of the second subassembly may define a succession of radial teeth.

A circumferential gap may exist between the radial teeth of the radially external surface of the first subassembly and the radial teeth of the radially internal surface of the second subassembly and, starting at a certain threshold of overtorque, this circumferential gap is closed by the abutting of the teeth with one another. This abutting of teeth of the radially external surface of the first sub-component against teeth of the radially internal surface of the second sub-component produces a solid stop making it possible to limit the elastic deformation in the circumferential sense of the connecting means and therefore to protect this connecting means against excessive deformations that could damage it.

Each radial tooth of the radially external surface of the first subassembly may be disposed circumferentially between two consecutive radial teeth of the radially internal surface of the second subassembly, in such a way that, in a trajectory over a given periphery, an alternation of radial teeth of the radially external surface of the first subassembly and of radial teeth of the radially internal surface of the second subassembly is found.

Each radial tooth of the radially internal surface of the second subassembly belongs, for example, to the support of the pendulum-type damping device.

The connecting means may then be connected to the first subassembly via the radial teeth thereof and be connected to the second subassembly via the radial teeth thereof.

According to a first exemplary embodiment of the invention, the connecting means is a waved washer fixed both on the first subassembly and on the second subassembly, especially on the support of the pendulum-type damping device. This washer has, for example, along a circumferential trajectory, a succession of zones axially offset in pairs. Such a washer is obtained, for example, from a washer of the Onduflex® type.

According to this first exemplary embodiment, the component may comprise first elements for fixation of the waved washer on the first subassembly and second elements for fixation of the waved washer on the second subassembly, wherein each first element alternates circumferentially with a second fixation element.

The washer has, for example:
a plurality of first portions, wherein each first portion receives a first element for fixation of the waved washer on the first subassembly and
a plurality of second portions, wherein each second portion receives a second element for fixation of the waved washer on the second subassembly,
   wherein each first portion of the waved washer alternates with a second portion of the waved washer in the circumferential sense.

The first portions may occupy a common axial position that is the same as that occupied by the second portions. The waved washer then comprises other portions offset axially relative to these first and second portions.

The first and second connecting elements may be identical to one another, for example in the form of rivets.

According to the first exemplary embodiment of the invention, the waved washer may carry at least one arm that is axially braced against one of the first and of the second subassembly. This arm may then be disposed radially in the prolongation of a portion of the waved washer receiving a second element for fixation of the waved washer to the other of the first and of the second subassembly.

Such an arm not only may limit the relative axial displacement between the first and the second subassembly, especially in case of axial pumping or flexions taking place around an axis perpendicular to the axis of rotation of the support, but it may also permit the exertion of friction between the first and the second subassembly. This friction may then make it possible to absorb part of the energy associated with overtorques.

According to a first variant, the arm becomes axially braced against the second subassembly and is disposed radially in the prolongation toward the exterior of a first portion of the waved washer, wherein this first portion receives a first fixation element. According to this variant, the component may comprise as many arms as there are first elements for fixation of the waved washer on the first subassembly. According to this first variant, the arm may be integral with the first subassembly.

According to a second variant, the arm becomes axially braced against the first subassembly and is disposed radially in the prolongation toward the interior of a second portion of the waved washer, wherein this second portion receives a second fixation element. According to this variant, the component may comprise as many arms as there are second elements for fixation of the waved washer to the second subassembly. According to this second variant, the arm may be integral with the second subassembly.

Alternatively, the component comprises:
at least one arm axially braced against the second subassembly, wherein this arm is disposed radially in the prolongation toward the exterior of a first portion of the waved washer, this first portion receives a first fixation element and this arm is in particular integral with the first subassembly, and
at least one arm axially braced against the first subassembly, wherein this arm is disposed radially in the prolongation toward the interior of a second portion of the waved washer, this second portion receives a second fixation element and this arm is in particular integral with the second subassembly.

According to this variant, the number of arms may be equal to the sum of the number of first fixation elements and the number of second fixation elements.

According to a second exemplary embodiment of the invention, the connecting means comprises a plurality of waved tabs disposed in circumferential succession, wherein each waved tab is fixed both on the first subassembly and on the second subassembly, especially on the support of the pendulum-type damping device. The presence of these different waved tabs may make it possible to distribute the circumferential deformations more effectively and, as the case may be, the aforesaid axial pumping or the flexions, which will be compensated completely or partly by the connecting means. Furthermore, the cost of the connecting means may be reduced.

As an example, the number of waved tabs ranges between two and six, and in particular is equal to four.

Each waved tab has, for example, along a circumferential trajectory, a succession of zones axially offset in pairs.

Each waved tab may be fixed on the first subassembly via at least one fixation element and on the second subassembly via at least one second, fixation element, wherein the waved tabs are positioned in such a way that, in a trajectory over a given periphery, an alternation of first and second fixation elements is found. Stated otherwise, the waved tabs disposed in circumferential succession are then not mounted head-to-tail.

The first and second connecting elements may be identical to one another, for example in the form of rivets.

Each waved tab has, for example:
a first portion receiving a first element for fixation of the waved tab on the first subassembly and
a second portion receiving a second element for fixation of the waved tab on the second subassembly.

From one waved tab to the other, the first or respectively second portion may occupy a given circumferential position on the tab.

Within a given waved tab, the first portion may occupy the same axial position as that occupied by the second portion. The waved washer then comprises at least one portion offset axially relative to these first and second portions.

According to the second exemplary embodiment of the invention, the waved tab may carry at least one arm that becomes axially braced against one of the first and of the second subassembly. This arm may then be disposed radially in the prolongation of a portion of the waved tab receiving a second element for fixation of the waved washer to the other of the first and of the second subassembly.

Such an arm not only may limit the relative axial displacement between the first and the second subassembly, especially in case of axial pumping or flexions taking place around an axis perpendicular to the axis of rotation of the support, but it may also permit the exertion of friction between the first and the second subassembly in order to permit absorption of part of the energy associated with overtorques.

According to a first variant, the arm becomes axially braced against the second subassembly and is disposed radially in the prolongation toward the exterior of a first portion of the waved tab, wherein this first portion receives a first fixation element. According to this variant, the component may comprise as many arms as there are first fixation elements, considering all waved tabs. According to this first variant, the arm may be integral with the first subassembly.

According to a second variant, the arm becomes axially braced against the first subassembly and is disposed radially in the prolongation toward the interior of a second portion of the waved tab, wherein this second portion receives a second fixation element. According to this variant, the component may comprise as many arms as there are second fixation elements, considering all waved tabs. According to this second variant, the arm may be integral with the second subassembly.

Alternatively, the component comprises:
at least one arm axially braced against the second subassembly, wherein this arm is disposed radially in the prolongation toward the exterior of a first portion of a waved tab, this first portion receives a first fixation element and this arm is in particular integral with the first subassembly, and
at least one arm axially braced against the first subassembly, wherein this arm is disposed radially in the prolongation toward the interior of a second portion of a waved tab, this second portion receives a second fixation element and this arm is in particular integral with the second subassembly.

According to this variant, the number of arms may be equal to the sum of the number of first fixation elements and the number of the second fixation elements, considering all waved tabs.

According to the second exemplary embodiment, at least one waved tab may comprise a portion forming an axial reciprocation capability, wherein the said portion is received in the free space provided circumferentially between the first subassembly and the second subassembly and defining the aforesaid circumferential gap.

According to one or other of the foregoing exemplary embodiments, the connecting means may be made of steel or of spring steel.

In all of the foregoing, the pendulum-type damping device may comprise a support capable of rotational movement around an axis and at least one pendulum-type member capable of moving relative to the support, wherein the displacement of this pendulum-type member is guided by at least one rolling means.

In all of the foregoing, the pendulum-type damping device may comprise two rolling means guiding the displacement of this pendulum-type mass relative to the support.

Each rolling means may cooperate with at least one first rolling track integral with the support and with at least one second rolling track integral with the pendulum-type mass.

According to a first preferred embodiment of the second subassembly of the component, the pendulum-type damping device comprises a single support and each pendulum-type member comprises a first pendulum-type mass disposed axially on a first side of the support and a second pendulum-type mass disposed axially on a second side of the support, wherein the first and the second pendulum-type masses are rigidly connected with one another by one or more connecting crosspieces.

According to this first preferred embodiment, each rolling means may cooperate with a single first rolling track and with a single second rolling track, and this second rolling track is defined by a connecting crosspiece of the pendulum-type member. As an example, one portion of the contour of this connecting crosspiece defines the second rolling track. Alternatively, a lining may be deposited on this portion of the contour of this connecting crosspiece to form the second rolling track. As an example, such a connecting crosspiece is force-fitted via each of its axial ends into an opening provided in one of the pendulum-type masses. Alternatively, the connecting crosspiece may be welded or screwed or riveted via its axial ends onto each of the first and of the second pendulum-type mass.

According to this first preferred embodiment of the second subassembly of the component, the displacement of each pendulum-type member relative to the support may be guided by at least two rolling means, especially by exactly two rolling means. Two connecting crosspieces, each cooperating with a rolling means, may be provided.

Each rolling means may then be subjected only to compression between the first and second rolling tracks mentioned hereinabove. These first and second rolling tracks cooperating with a given rolling means may be in radially facing relationship, at least partly. In other words, planes perpendicular to the axis of rotation exist in which both of these rolling tracks extend.

According to the first preferred embodiment, each rolling means may be received in a window of the support that already receives a connecting crosspiece but does not receive any other rolling means. As an example, this window is defined by a closed contour, one portion of which defines the first rolling track integral with the support that cooperates with that rolling means.

According to a second preferred embodiment of the second subassembly of the component, the pendulum-type damping device also comprises a single support and the pendulum-type member also comprises a first and a second pendulum-type mass offset axially and rigidly connected with one another by one or more connecting crosspieces, but each rolling means cooperates on the one hand with a single first rolling track integral with the support and on the other hand with two second rolling tracks integral with the pendulum-type member. Each pendulum-type mass then has an opening, one part of the contour of which defines one of these second rolling tracks.

According to this second preferred embodiment, each connecting crosspiece groups several rivets, for example, and this connecting crosspiece is received in a window of the support, while the rolling means is received in an opening of the support distinct from a window receiving a connecting crosspiece.

According to this second preferred embodiment, two rolling means may guide the displacement of the pendulum-type member relative to the support, and each rolling means cooperates with a first rolling track dedicated to this rolling means and with two second rolling tracks dedicated to this rolling means.

According to this second preferred embodiment, each rolling means may then comprise, axially in succession:
a portion disposed in an opening of the first pendulum-type mass and cooperating with the second rolling track formed by a part of the contour of this opening,
a portion disposed in an opening of the support and cooperating with the first rolling track formed by a part of the contour of this opening, and
a portion disposed in an opening of the second pendulum-type mass and cooperating with the second rolling track formed by a part of the contour of this opening.

According to the first or the second preferred embodiment, two distinct connecting means may connect the support of the pendulum-type damping device to the first sub-element, wherein a first connecting means is disposed axially on a first side of the support and a second connecting means is disposed axially on a second side of the support.

As an example, each of these two connecting means corresponds to the first or respectively the second exemplary embodiment such as described hereinabove. Alternatively, the first connecting means corresponds to the first exemplary embodiment such as described hereinabove and the second connecting means corresponds to the second exemplary embodiment such as described hereinabove.

According to a third preferred embodiment, the pendulum-type damping device comprises two axially offset and integral supports, wherein the pendulum-type member then comprises a single pendulum-type mass disposed axially between the two supports, or the pendulum-type member comprises several pendulum-type masses integral with one another. All of these pendulum-type masses of a given pendulum-type member may be disposed axially between the two supports. Alternatively, only certain pendulum-type mass(es) of the pendulum-type member extend(s) axially between the two supports, wherein other pendulum-type mass(es) of this pendulum-type member extend axially(s) beyond one or other of the supports.

According to this third preferred embodiment, only one connecting means is provided between the first subassembly and the second subassembly of the component. This connecting means, which is, for example, a waved washer according to the first exemplary embodiment hereinabove or a plurality of waved tabs according to the second exemplary embodiment hereinabove, connects only one of the supports to the first subassembly of the component.

According to one variant of this third preferred embodiment, two distinct connecting means may be provided between the first subassembly and the second subassembly of the component:
a first connecting means, for example a waved washer according to the first exemplary embodiment hereinabove or a plurality of waved tabs according to the second exemplary embodiment hereinabove, connects the first support to the first subassembly, and
a second connecting means, identical to or different from the first connecting means, connects the second supports to the first subassembly of the component.

In all of the foregoing, the pendulum-type damping device may comprise at least one damping means abutting the pendulum-type member against the support in the following positions:
the position at the end of a displacement of this pendulum-type member in the trigonometric sense from the rest position in order to filter a torsional oscillation, and/or
the position at the end of a displacement of this pendulum-type member in the non-trigonometric sense from the rest position in order to filter a torsional oscillation.

This abutting damping means is then carried by the pendulum-type member and is capable of coming simultaneously into contact with the pendulum-type member and the support for all or part of the aforesaid relative positions of the pendulum-type member relative to the support.

Each abutting damping means may be dedicated to a connecting crosspiece of the pendulum-type member when this latter has two pendulum-type masses connected to one another by such a connecting crosspiece. Each abutting damping means may have elastic properties permitting damping of shocks associated with the abutting of the pendulum-type member against the support. This damping is then permitted by compression of the complementary abutting damping means, wherein this latter is made, for example, of elastomer or rubber.

In all of the foregoing, at least one among the support and the pendulum-type member may carry an axial interposed piece, wherein this axial interposed piece is in particular a lining deposited on the support or on the pendulum-type mass. Alternatively, the axial interposed piece may be a runner carried by the support or by the pendulum-type member. This runner may be of plastic and it may be fastened on the support or respectively on the pendulum-type member via one or more fixation hooks mounted in one or more holes of the support or respectively of the pendulum-type member. Such an interposed piece is therefore able to limit the axial displacement of the pendulum-type member relative to the support, thus avoiding the axial shocks between the said pieces, and thus wear and undesired noise, especially when the support and/or the pendulum-type mass are of metal.

As an example, each rolling means is a roller of circular section in a plane perpendicular to the axis of rotation of the support. This roller may comprise several successive cylindrical portions of different radius. The axial ends of the roller may be free of terminal annular shoulders. As an example, the roller is made of steel. The roller may be hollow or solid.

In all of the foregoing, the device comprises, for example, a number of pendulum-type members between two and eight, especially three, four, five or six pendulum-type members. All of these pendulum-type members may be in circumferential succession. The device may therefore comprise a plurality of planes that are perpendicular to the axis of rotation and in each of which all of the pendulum-type members are disposed.

In all of the foregoing, the shape of the aforesaid first and second rolling tracks may be such that each pendulum-type member is displaced only relative to the support by translation around an imaginary axis parallel to the axis of rotation of the support.

Alternatively, the shape of the rolling tracks may be such that each pendulum-type member is displaced relative to the support both:
by translation around an imaginary axis parallel to the axis of rotation of the support, and
also by rotation around the center of gravity of the said pendulum-type mass, wherein such a movement is also known as “combined movement”.

Each pendulum-type member may be assigned to the excitation order of a two-cylinder combustion engine, also known as “1st order”.

In all of the foregoing, the support may be made in one piece which, for example, is completely metallic.

The component may be a damping double flywheel, a hydrodynamic torque converter, a flywheel integral with the crankshaft, a dry or wet double clutch, a hybrid transmission system component, a simple wet clutch or a clutch friction disk.

The support of the pendulum-type damping device may then be one from among:
a shroud of the component,
a guide washer of the component,
a phasing washer of the component, or
a distinct support of the said shroud, of the said guide washer and of the said phasing washer.

The support may be disposed at the inlet or at the outlet of the components, wherein the terms “inlet” and “outlet” will be understood in the sense of transmission of the engine torque from the crankshaft toward the vehicle wheels.

In the case in which the device is integrated in a flywheel integral with the crankshaft, the support may be integral with this primary flywheel.

In one particular case, the component forms a clutch friction disk. The first subassembly then comprises the hub of the friction disk. In this case, the radial teeth of the first subassembly may be defined by the radially external surface of this hub.

In this particular case, the connecting means connects, for example, the hub of the friction disk to the support of the pendulum-type damping device.

According to another of its aspects, the invention also has as an object a vehicle transmission system component comprising:
a first subassembly having an input and an output, between which a torque can be transmitted, and
a second subassembly forming a pendulum-type damping device, and disposed outside the path of the torque transmitted by the first subassembly,
   wherein the first and the second subassemblies are connected to one another by at least one connecting means capable of being elastically deformed circumferentially,
   the connecting means carries at least one arm that becomes axially braced against one of the first and of the second subassembly, wherein this arm is disposed radially in the prolongation of a portion of the connecting means capable of receiving an element for fixation to the other of the first and of the second subassembly.

The arm may be distinct from the portion of the connecting means receiving the fixation element.

All of the foregoing may be applicable to this other aspect of the invention, especially the first or the second exemplary embodiment described in the foregoing.

The invention will be more understandable by reading the description hereinafter of non-limitative exemplary embodiments thereof and by examining the attached drawing, wherein:

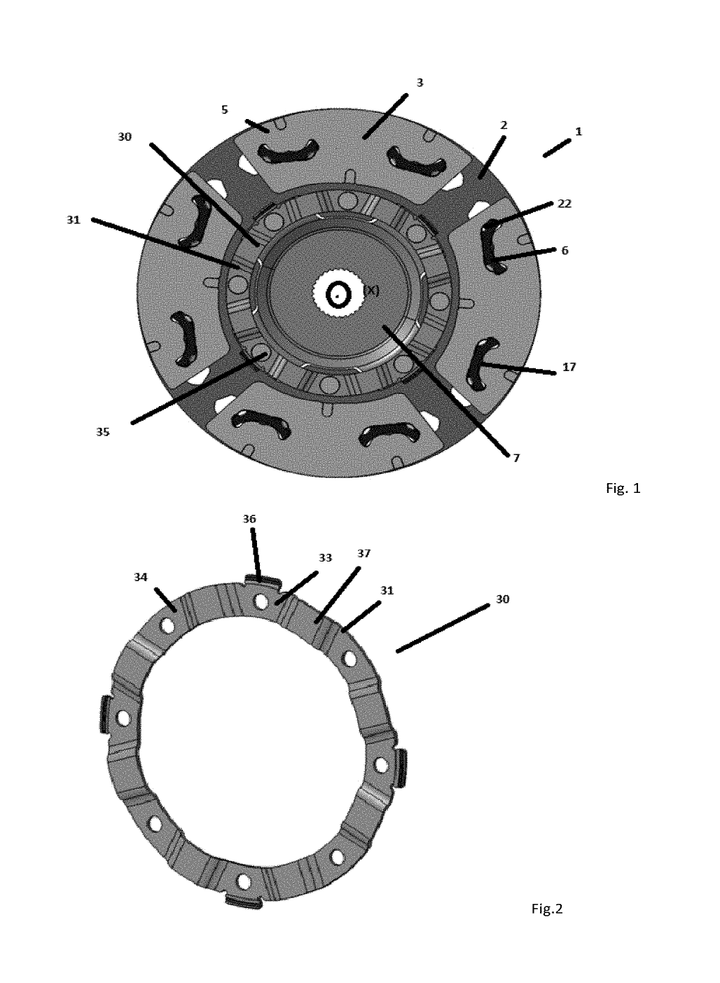

FIG. 1 schematically represents a transmission system component with a connecting means according to a first exemplary embodiment of the invention,

FIG. 2 represents the connecting means of FIG. 1 in isolation,

FIG. 3 represents a detail of FIG. 2,

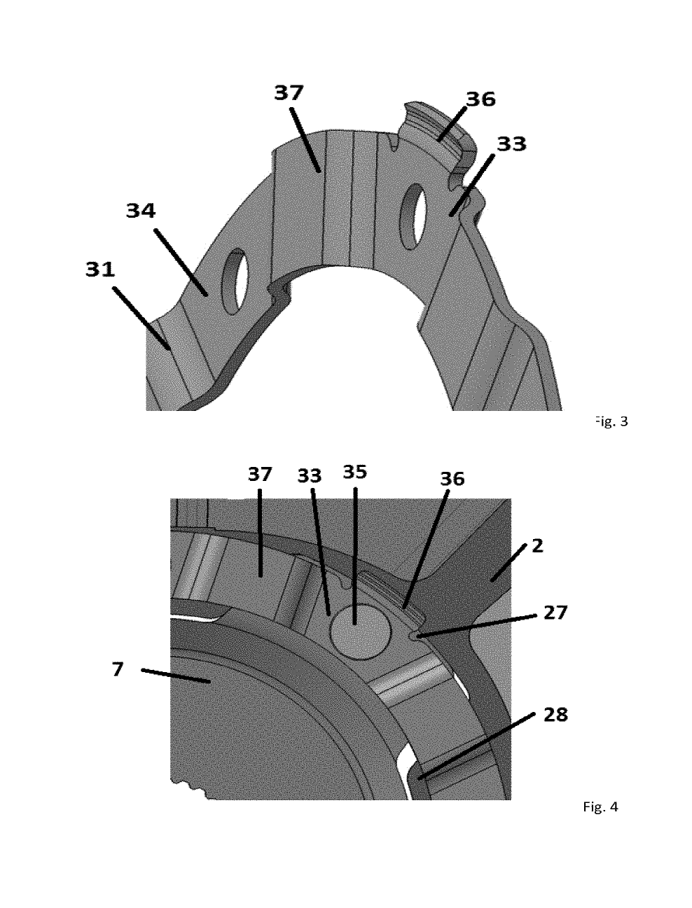

FIG. 4 represents a detail of FIG. 1,

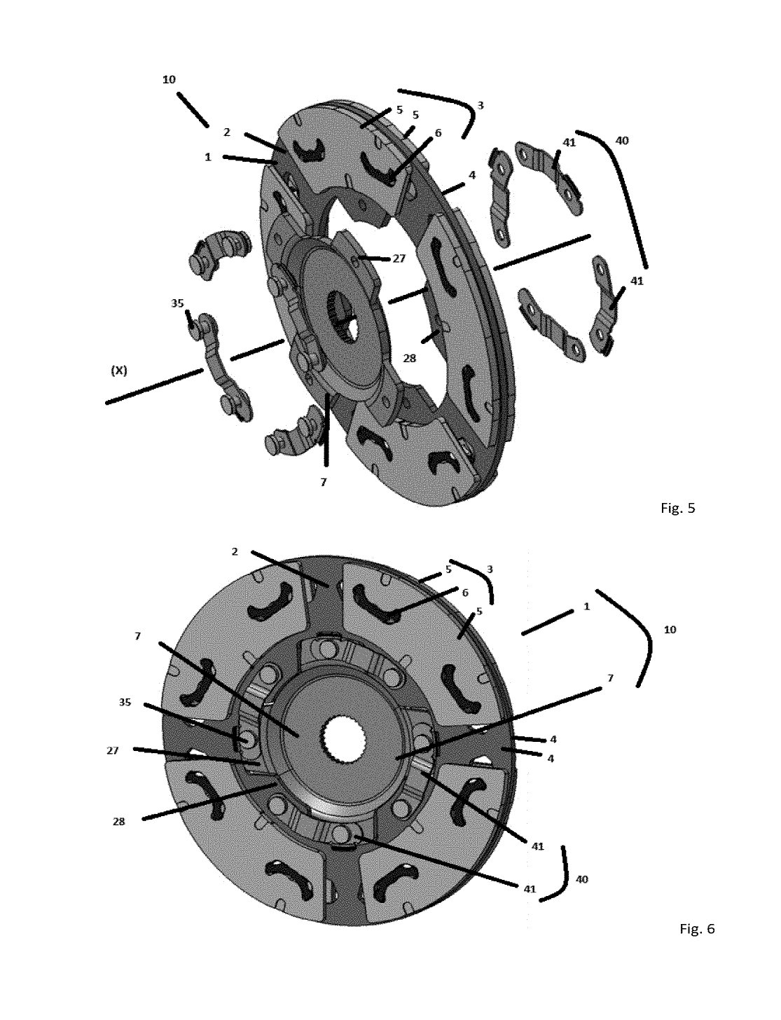

FIGS. 5 and 6 respectively represent, in the exploded state and in the assembled state respectively, a transmission system component with a connecting means according to a second exemplary embodiment of the invention,

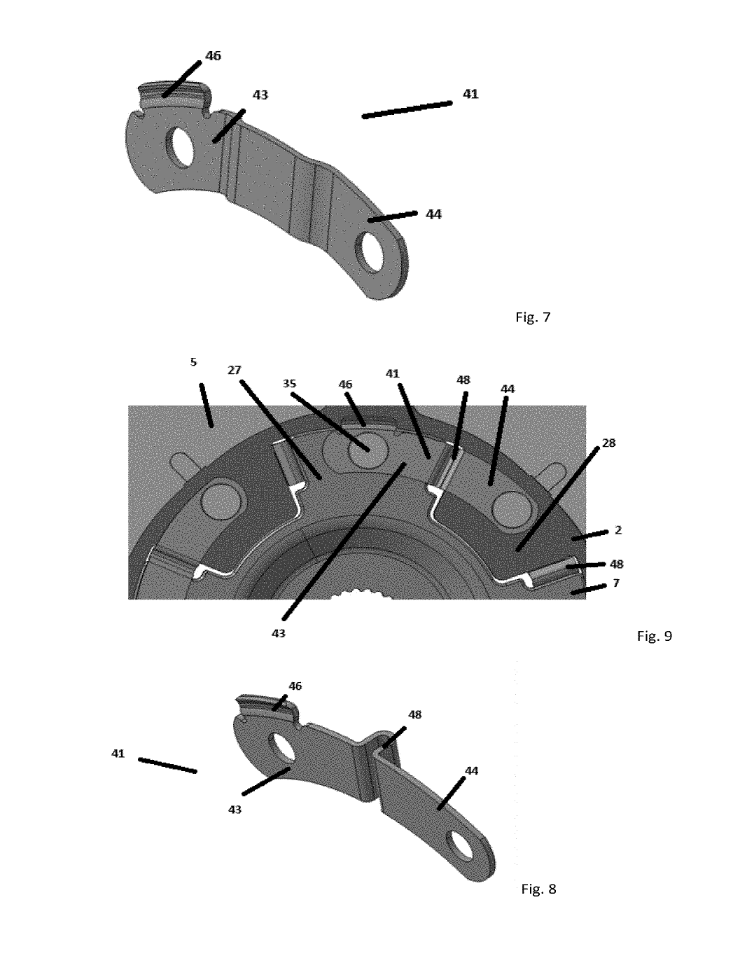

FIG. 7 represents a waved tab of a connecting means according to the second exemplary embodiment of the invention in isolation,

FIG. 8 represents, similarly to FIG. 7, a waved tab of an alternative of the second exemplary embodiment of the invention, and

FIG. 9 is a partial view of a transmission system component equipped with tabs according to FIG. 8.

FIGS. 1 to 4 represent a transmission system component 10 according to a first exemplary embodiment of the invention.

Here, this component 10 is a clutch friction disk, for example associated with a combustion engine, especially with two, three or four cylinders. Here, component 10 comprises:
a first subassembly having an input and an output, between which a torque can be transmitted, and
a second subassembly forming a pendulum-type damping device 1, and disposed outside the path of the torque transmitted by the first subassembly.

Of the first subassembly, FIG. 1 shows only hub 7 of the friction disk defining the torque output of this subassembly. The torque input of this first subassembly is formed in known manner by friction coatings, not illustrated.

In the example under consideration, pendulum-type damping device 1 formed by the second subassembly comprises:
a support 2 capable of being displaced by rotation around an axis X, and
a plurality of pendulum-type members 3 capable of moving relative to support 2.

In the example under consideration, four pendulum-type members 3 are provided and are uniformly distributed over the periphery of axis X.

Support 2 here is made in one piece, in the form of a plate extending between two substantially parallel sides 4.

As can be seen in the figures, each pendulum-type member 3 comprises, in the example under consideration:
two pendulum-type masses 5, wherein one of these pendulum-type masses 5 is a first pendulum-type mass 5 disposed axially facing a first side 4 of the support, while the other of these pendulum-type masses 5 is a second pendulum-type mass 5 disposed axially facing a second side 4 of support 2, and
two connecting crosspieces 6 making the two pendulum-type masses 5 integral with one another.

In the example under consideration, connecting crosspieces 6 are offset angularly.

In the figures, pendulum-type damping device 1 is at rest, and so it is not filtering the torsional oscillations propagating in the transmission system due to rotational irregularities of the combustion engine.

In the example of the figures, each end of a connecting crosspiece 6 is force-fitted into an opening 17 provided in a respective pendulum-type mass, in such a way as to make these two pendulum-type masses 5 integral with one another. In variants, each of these ends could be riveted or welded, or screwed onto one of the pendulum-type masses 5. Each connecting crosspiece 6 extends partly into a window provided in support 2, wherein this window defines an empty space, bounded by a closed contour 20, in the interior of support 2.

Although they are not illustrated, device 1 also comprises, in the example under consideration, rolling means guiding the displacement of pendulum-type members 3 relative to support 2. As an example, the rolling means are rollers.

In the described example, the movement of each pendulum-type member 3 relative to support 2 is guided by two rolling means, wherein each of these cooperates here with one of the connecting crosspieces 6 of pendulum-type member 3.

Here, each rolling means cooperates with a single first rolling track integral with support 2 and with a single second rolling track integral with pendulum-type member 3 in order to guide the displacement of this pendulum-type member 3.

In the example under consideration, each second rolling track is formed by a portion of the radially external rim of a connecting crosspiece 6.

Each first rolling track is defined by a part of the contour of an aforesaid window.

Each first rolling track is therefore disposed radially facing a second rolling track, in such a way that a given rolling surface of a rolling means rolls alternatively over the first rolling track and over the second rolling track. Here, the rolling surface of the rolling means is a cylinder of constant radius.

As can be surmised in FIG. 1 in particular, damping means 22 may be provided for abutting pendulum-type member 3 against support 2. Each connecting crosspiece 6 is then associated with such an abutting damping means 22, wherein each of these latter is configured to be interposed between this connecting crosspiece 6 and the radially interior rim of the window receiving this connecting crosspiece 6.

As can be seen in the figures, at least one connecting means 30 connects hub 7 of the friction disk to support 2 of the pendulum-type damping device. This connecting means 30 may be deformed elastically in the circumferential sense and, advantageously, also in the axial sense.

As is obvious in FIG. 4 in particular, here the radially external surface of hub 7 of the friction disk defines a succession of radial teeth 27, and the radially internal surface of support 2 of pendulum-type damping device 1 defines a succession of radial teeth 28.

FIG. 4 also shows that each radial tooth 28 is disposed circumferentially between two consecutive radial teeth 27, in such a way that, in a trajectory over a given periphery, an alternation of radial teeth 27 and of radial teeth 28 is found.

According to the first exemplary embodiment of the invention as described with reference to FIGS. 1 to 4, the connecting means is a waved washer 31.

This waved washer 31 is fixed both to hub 7 of the friction disk via radial teeth 27 and to support 2 of pendulum-type damping device 1 via radial teeth 28. This waved washer 31 has, for example, along a circumferential trajectory, a succession of zones axially offset in pairs Such a washer is obtained, for example, on the basis of a washer of the Onduflex® type. It is apparent that component 1 comprises first elements 35 for fixation of waved washer 31 on radial teeth 27 of hub 7 of friction disk 1, and second elements 35 for fixation of waved washer 31 on support 2 of pendulum-type damping device 1.

It is apparent in FIG. 1 that each first fixation element 35 alternates circumferentially with a second fixation element 35. Here, all of these fixation elements 35 are rivets.

It is also apparent in FIGS. 1 to 4 that waved washer 31 may have:
a plurality of first portions 33, wherein each first portion 33 receives a first element 35 for fixation of waved washer 31 on hub 7 of the friction disk, and
a plurality of second portions 34, wherein each second portion 34 receives a second element 35 for fixation of waved washer 31 on support 2 of pendulum-type damping device 1.

Furthermore, it is apparent that each first portion 33 of waved washer 31 alternates with a second portion 34 of waved washer 31 in the circumferential sense.

It is also apparent in FIG. 2 that first portions 33 of waved washer 31 occupy, in the example under consideration, a given axial position, which is also that occupied by second portions 34 of this washer 31. Portions 37 of waved washer 31, which are offset axially relative to these first 33 and second 34 portions, also exist.

It is also apparent, especially in FIGS. 2 and 3, that waved washer 31 may carry a plurality of arms 36 that become braced axially against support 2 of pendulum-type damping device 2. Here, each arm 36 is disposed radially in the prolongation of a portion 33 of waved washer 31 receiving a first element 35 for fixation on hub 7 of the friction disk. Here, such an arm 36 has a curved free end that makes frictional contact against support 2 via axial bracing.

It is apparent in FIG. 1 that the number of arms 36 may be equal to the number of first fixation elements 35.

As an example, waved washer 31 is made of steel or of spring steel.

A single connecting means 30 is illustrated in FIGS. 1 to 4. However, component 1 may comprise two distinct connecting means 30, wherein each connecting means 30 is then formed by a waved washer 31 such as described in the foregoing. Each washer 31 is then disposed axially on only one side of support 2. In this case, first fixation elements 35 may be common to both connecting means 30, just as may second fixation elements 35. Stated otherwise, a given rivet 35 may, in the described example, connect on the one hand hub 7 to waved washer 31 of first connecting means 30 and on the other hand to waved washer 31 of the second connecting means. Two alternatives of a component with a connecting means 40 according to a second exemplary embodiment of the invention will now be described with reference to FIGS. 5 to 9.

FIGS. 5 to 9 show that two connecting means 40 are provided here, wherein one of these connecting means 40 is disposed axially on a first side 4 of support 2 of pendulum-type damping device 1, while the other connecting means 40 is disposed axially on a second side 4 of this support 2.

According to this second exemplary embodiment of the invention, connecting means 40 is formed by a plurality of waved tabs 41 disposed in circumferential succession, wherein each waved tab 41 is fixed both on the first subassembly and on the second subassembly. Here, each waved tab 41 is fixed to one radial tooth 27 of hub 7 of the clutch disk and to one radial tooth 28 of support 2 of pendulum-type damping device 1.

Here the number of waved tabs 41 is equal to four.

Here, each waved tab 41 has, along a circumferential trajectory, a succession of zones axially offset in pairs. Each waved tab 41 is fixed to one radial tooth 27 of hub 7 of the friction disk via a first fixation element 35, and it is fixed to one radial tooth 28 of support 2 of pendulum-type damping device 1 via a second fixation element 35. It is apparent that waved tabs 41 are positioned in such a way that, in a trajectory over a given periphery, an alternation of first and second fixation elements is found.

Each waved tab 41 has, in FIGS. 5 to 9:
a first portion 43 receiving a first element 35 for fixation of waved tab 41 on hub 7 of the friction disk, and
a second portion 44 receiving a second element 35 for fixation of waved tab 41 on support 2 of pendulum-type damping device 1.

It is also apparent in FIGS. 5 to 9 that, from one waved tab to the other, the first or respectively second portion occupies the same circumferential position on the tab.

It is also apparent in FIGS. 5 to 9 that, within a given waved tab 41, the first portion 43 and the second portion 44 occupy the same axial position. The waved washer then comprises a portion offset axially relative to these first 43 and second 44 portions.

The first 35 and second 35 connecting elements may be identical to one another, here in the form of rivets common to both connecting means 40.

Similarly to the first exemplary embodiment described in the foregoing, each waved tab 41 may carry an arm 46 that becomes braced axially against support 2 of pendulum-type damping device 1. Here, this arm 46 is disposed radially in the prolongation of a first portion 43 of waved tab 41. As an example, arm 46 has a curved free end that makes frictional contact against support 2 via axial bracing.

The alternative of FIGS. 8 and 9 is distinguished from that according to FIGS. 5 to 7 by the fact that portion 48 of waved tab 41, which is axially at a distance from first 43 and second 44 portions of this waved tab 41, forms an axial reciprocating capability received in a free space provided circumferentially between a tooth 27 of hub 7 of the friction disk and a tooth 28 of support 2 of pendulum-type damping device 1.

According to the second exemplary embodiment of the invention, each tab 41 may be made of steel or of spring steel.

Friction disk 1 may comprise a damper and, as the case may be, also a pre-damper.

The invention is not limited to the examples that have just been described.

1. A vehicle transmission system component, comprising:
a first subassembly having an input and an output, between which a torque can be transmitted, and
a second subassembly forming a pendulum-type damping device, and disposed outside the path of the torque transmitted by the first subassembly,
wherein the first and the second subassemblies are connected to one another by at least one connecting means capable of being elastically deformed circumferentially, wherein this connecting means comprises at least one waved part.

2. The component according to claim 1, wherein the connecting means can also be elastically deformed axially.

3. The component according to claim 1, wherein the second subassembly is disposed radially exterior to the first subassembly, the radially external surface of the first subassembly defines a succession of radial teeth, and the radially internal surface of the second subassembly defines a succession of radial teeth.

4. The component according to claim 3, wherein each radial tooth of the radially external surface of the first subassembly is disposed circumferentially between two consecutive radial teeth of the radially internal surface of the second subassembly, in such a way that, in a trajectory over a given periphery, an alternation of radial teeth of the radially external surface of the first subassembly and of radial teeth of the radially internal surface of the second subassembly is found.

5. The component according to claim 1, wherein the connecting means is a waved washer fixed both on the first subassembly and on the second subassembly.

6. The component according to claim 5, comprising first elements for fixation of the waved washer on the first subassembly and second elements for fixation of the waved washer on the second subassembly, wherein each first fixation element alternates circumferentially with a second fixation element.

7. The component according to claim 5, wherein the waved washer carries at least one arm that becomes axially braced against one of the first and of the second subassembly.

8. The component according to claim 6, wherein the arm is disposed radially in the prolongation of a portion of the waved tab receiving an element for fixation to the other of the first and of the second subassembly.

9. The component according to claim 1, wherein the connecting means comprises a plurality of waved tabs disposed in circumferential succession, and each waved tab is fixed both on the first subassembly and on the second subassembly.

10. The component according to claim 9, wherein each waved tab is fixed on the first subassembly via at least one first fixation element and on the second subassembly via at least one second, fixation element, and the waved tabs are positioned in such a way that, in a trajectory over a given periphery, an alternation of first and second fixation elements is found.

11. The component according to claim 9, wherein at least one waved tab carries an arm that becomes axially braced against one of the first and of the second subassembly.

12. The component according to claim 11, wherein the arm is disposed radially in the prolongation of a portion of the waved tab receiving an element for fixation to the other of the first and of the second subassembly.

13. The component according to claim 9, wherein at least one waved tab comprises a portion forming an axial reciprocation capability, and the said portion is received in a free space provided circumferentially between the first subassembly and the second subassembly.

14. The component according to claim 1, wherein the connecting means is made of steel or of spring steel.

15. The component according to claim 1, forming a clutch friction disk.

16. A vehicle transmission system component, comprising:
a first subassembly having an input and an output, between which a torque can be transmitted, and
a second subassembly forming a pendulum-type damping device, and disposed outside the path of the torque transmitted by the first subassembly,
wherein the first and the second subassemblies are connected to one another by at least one connecting means capable of being elastically deformed circumferentially.
the connecting means carries at least one arm that becomes axially braced against one of the first and of the second subassembly, and this arm is disposed radially in the prolongation of a portion of the connecting means capable of receiving an element for fixation to the other of the first and of the second subassembly.

17. The component according to claim 2, wherein the second subassembly is disposed radially exterior to the first subassembly, the radially external surface of the first subassembly defines a succession of radial teeth, and the radially internal surface of the second subassembly defines a succession of radial teeth.

18. The component according to claim 4, wherein the connecting means is a waved washer fixed both on the first subassembly and on the second subassembly.

19. The component according to claim 6, wherein the waved washer carries at least one arm that becomes axially braced against one of the first and of the second subassembly.

20. The component according to claim 7, wherein the arm is disposed radially in the prolongation of a portion of the waved tab receiving an element for fixation to the other of the first and of the second subassembly.
